(19) United States
(12) Patent Application Publication
(10) Pub. No.: US 2006/0082908 A1
(43) Pub. Date: Apr. 20, 2006

(54) "Little bit's" blind spot safety device with reflectors

(76) Inventor: Tammy Lynn Bryson, Nashville, TN (US)

Correspondence Address: Tammy L. Bryson, 4913 Trousdale Dr., Nashville, TN, 37220, US

(21) Appl. No.: 11/251,478

(22) Filed: Oct. 14, 2005

Related U.S. Application Data
(60) Provisional application No. 60/619,530, filed on Oct. 14, 2004.

(51) Int. Cl. G02B 7/182

(52) U.S. Cl. 359/865

(57) ABSTRACT

A Blind Spot Safety Device with reflectors (16) identifying all blind spot areas and their perimeter, using adhesive glue to secure decal (10) and reflectors (16) to metal backing (18) which is then attached using the perforation screw attachment (18a). Eye-catching artistic signage and reflective angelic design is used to draw the eyes of other drivers to see the Precautionary Warning Blind Spot (12) Danger I can't see You! (14).

### CROSS-REFERENCE TO RELATED APPLICATIONS

This application claims the benefit of provisional patent Ser. No. 60/619,530, filed 2004 Oct. 14 by the present inventor.

### FEDERALLY SPONSORED RESEARCH NOT APPLICABLE

### SEQUENCE LISTING OR PROGRAM NOT APPLICABLE

### BACKGROUND OF THE INVENTION

1. Field of Invention

This invention relates to a safety device specifically used to identify Blind Spot areas.

2. Prior Art

I have developed a better way of protecting both the professional Truck Drivers and the automobile drivers from the dangers of blind spots. I have done this by creating a blind spot safety device with an adhesive glued decal made of reflective materials with U.V. protection emphasizing a precautionary warning, which truckers can use to inform other drivers on the road of the exact location of all four blind spots on their trucks.

The Road Injury Prevention Litigation Journal reported that 70 percent of all fatal crashes involving automobiles and trucks could be contributed to the automobile driver.

Ample research over the last ten years by “Crash” (Citizens for reliable and safe Highways) has demonstrated, as trucks are continually being made bigger and bigger to increase productivity, they are becoming more unstable, and are having crashes which are more likely to result in death and serious injuries. There is a sharp increase in truck crash fatality rates with each extra ton on a truck. A typical fully loaded large commercial truck of today can weight 80,000 pounds, compared to trucks weighting 50,000 pounds just a few years ago. A truck weighting 80,000 pounds is more than twice as likely to be involved in a fatal crash than a truck weighting about 50,000 pounds when all other factors are equal.

The American Trucking Association (ATA) in response to growing industry needs and public safety concerns, have created “America's Road Team”, a select group of truck drivers chosen for their exemplary safety records to demonstrate to the American public the dangers of blind spots, explaining where they are and how to avoid them.

While statistics show that truck drivers are more careful on the road than automobile drivers, large truck crashes still accounted for 5,350 fatalities and 133,000 injuries in 2001.

“Employers also lose more than $50 billion a year in related legal expense, property damage, and lost of productivity. These accidents also effect auto and workers compensation premiums for all employers,” as quoted by Workers Com. Your Risk Management Guide Volume 8 Issue 5.

The Insurance Research council also estimates that more than one third of injury claims from car crashes involve fraud or deliberate exaggeration of injuries, adding between $5.2 Billion and $6.3 Billion a year to auto insurance policy holders bills.

“A claim adjustor has no obvious or simple way to separate legitimate claims from fraudulent ones. No matter how much someone suspects fraud; insurers cannot deny payment without solid proof,” reported State Farm Insurance company website

Seventeen to twenty cents of every dollar spent on insurance can be attributed to fraud or claim padding.

Other safety devices for the Commercial Trucking Industry do not identify all four blind spot areas of a truck. “Intec Video Systems, Inc. copyright 2001, 2002,” while providing a clear camera view down the side of the rig, still does not inform the automobile driver of the dangers of blind spots or their location.

The Warning Blind Spot Reflective Tape trademarked “Warning Blind Spot, Inc. Sep. 28, 2004, corporation Illinois”, also misses the mark, by not identifying all four blind spots and using a commercial design that is not appealing to Owner/Operators who are very concerned with the appearance of their truck.

All of these Prior-Art Inventions are assuming all automobile drivers know about the dangers of blind spots and their location, when the National Statistics prove otherwise. This assumption causes a number of disadvantages:
(a) Location of Blind Spots not known by the automobile driver.
(b) Automobile drivers are not continually made aware of the dangers of blind spots.
(c) Further commercial design does not appeal to the owner operators, nor does it catch the eye of the automobile driver, to warn them of the danger of blind spots.
(d) Camera and Video equipment can be expensive.
(e) Commercial Design also does not convey trust and safety to the automobile driver.

### BACKGROUND OF INVENTION—OBJECTS AND ADVANTAGES

Accordingly, besides the objects and advantages of the Blind Spot Safety Device described in my above patent, several objects and advantages of the present invention are:
(a) To provide a safety device that actually shows and marks the complete area of each blind spot;
(b) To provide a safety device that if an accident does occur, the truth is recorded upon impact, thus the Insurance companies are no longer left completely alone with the burden of proof.
(c) To provide a safety device that informs non-professional drivers immediately of the danger they can cause by insisting to remain in a professional driver's blind spot.

Further objects and advantages are to provide a safety device that is unique, and eye catching, adding beauty while conveying trust and safety by using animals/creatures with large eyes, surrounded with reflective materials which appear to be glowing angelically behind the animal. The fabrication and Digital Lintickler printing on reflective sheeting will preferably be done by Precision Signworks, Nashville, Tn. The solvent-based inks are provided by 3-M Corporation Center, Saint Paul, Min.

### SUMMARY

In accordance with the present invention a safety device used for identifying blind spot areas, with both artistic design and cautionary reflectors is both needed and wanted.

### DRAWINGS—FIGURES

The file of this patent contains at least one color drawing. The PTO upon payment of necessary fee will provide copies of the patent with color drawings.

In the drawings, closely related figures have the same number but different alphabetic suffixes.

FIG. 1 shows the metal backing with perforation screw backing used to secure and attach decal and reflectors to Tracker Trailers.

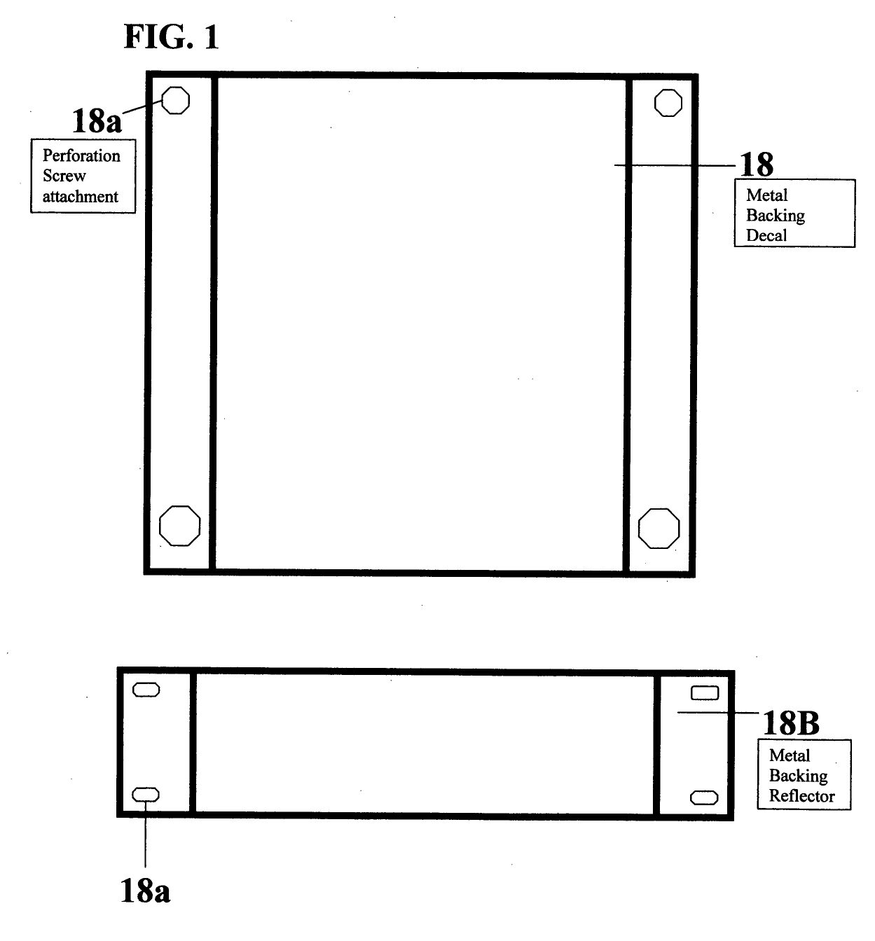

FIG. 2 shows the reflectors surrounding the blind spot area.

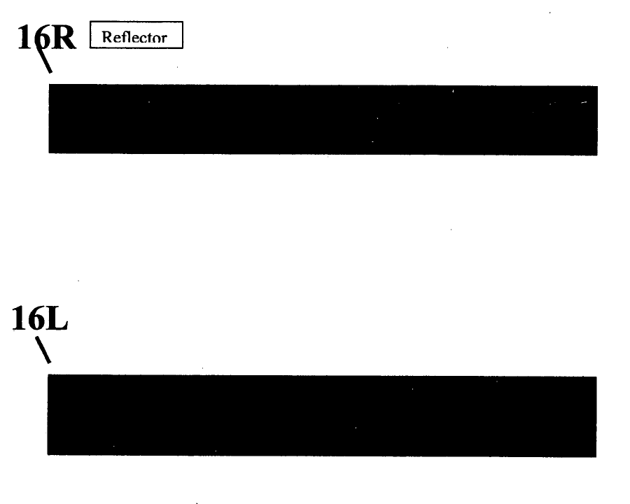

FIG. 3 shows the reflecting angelic design and eye catching unique appeal used to convey trust and safety, with precautionary words “Blind Spot, Danger I can't See You!”

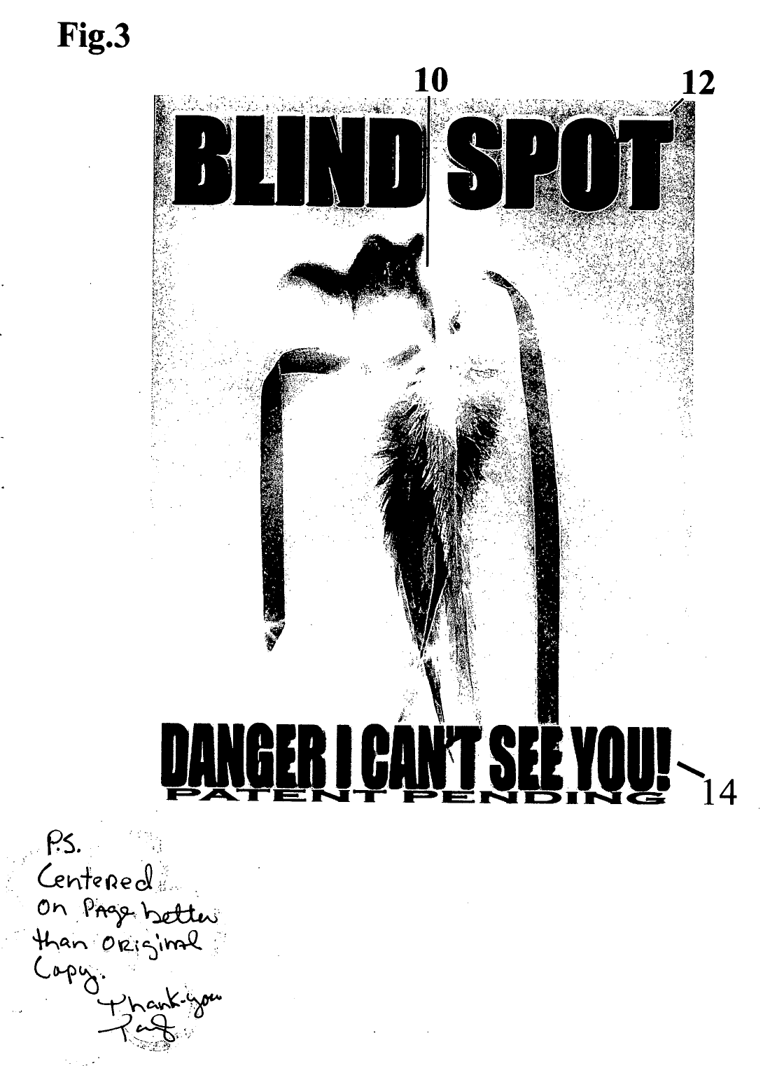

FIG. 4 shows complete utilization of Blind Spot Safety Device with reflectors identifying blind spot areas.

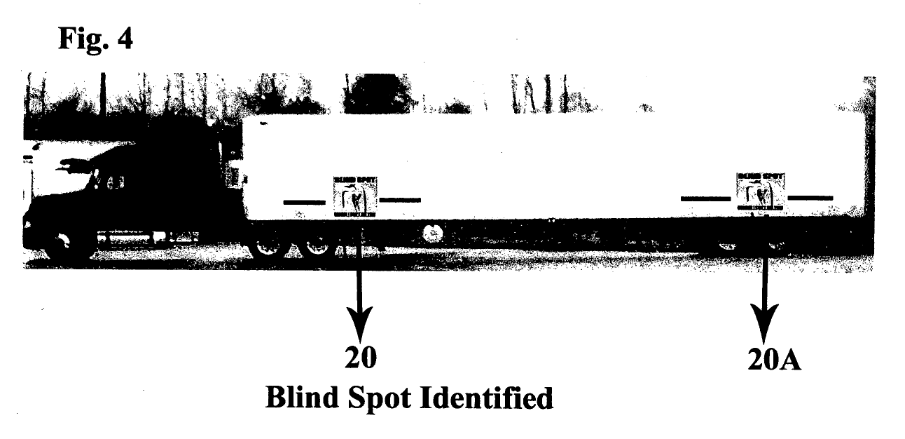

### DRAWINGS—REFERENCE NUMERALS

10 Decal
12 Blind spot printed in large bold print
14 Warning caption “Danger, I can't See You!”
16 Reflectors
18 Metal Backing
20 Blind Spot Identified

### DETAILED DESCRIPTION—FIGS.

The Little Bit's Blind Spot Safety Device with Reflectors has the words “Blind Spot printed in Large bold print, identified as number 12, followed by the warning caption 14, “Danger, I can't See You!” Reflectors 16L and 16R indicate the perimeter of the Blind Spot areas to avoid, acting both as a warning and a protection against fraud if an accident is caused by the other driver remaining in the professional driver's blind spot, as indicated at the moment of impact.

The base of Decal 10 is metal backing 18 with perforation screw attachment 18a, providing security when applied to Tractor Trailers. Metal backing 18b is used to secure the reflectors 16 on the Tractor Trailer.

To further secure the decal onto metal backing 18 adhesive glue is used to glue both Decal 10 and Reflector 16 onto Metal Backing 18.

Operational Description of Figures

The manner of using the Blind Spot Safety Device to warn other drivers of the dangers of Blind Spots is simply to apply all features described above as indicated by the instructions accompanying each set.

One places Decal 10 and Reflectors 16 onto each of the four blind spot areas of an Eighteen Wheeler 20. Using “1” inch screws and perforation screw attachment 18a.

Advantages

(a) The decal is made to be durable, with a 3-year guarantee under normal wear conditions. This works perfectly sense most Fleet Operators replace their trailers every 3 years.

(b) U.V. Protection

(c) Angelic beauty using reflective materials which makes features of decal to appear to be glowing, causing other drivers to notice the design features, thus becoming aware of blind spot.

(d) A better informed driver is a safer driver, proven by “America's Road Team.”

(e) Helps to prevent fraud;

(f) Bigger Trucks are more dangerous and the public needs To be aware of these dangers, so they can protect themselves and their families.

My Little Bit's Blind Spot Safety Device with Reflectors was made with the needs of the Professional Driver in mind, providing The ultimate protection for past, future, and present accidents, and would be accidents, because the burden of proof is in the truth.

Further, the Blind Spot Safety Device has the additional advantages in that

Eye catching signage

Fabrication and Digital Lintickler Printing on reflective sheeting;

Research by the American Trucking Association and the Traffic Bureau Audit has established that truck fleets are a powerful communication medium.

There are also many alternative ways that my Blind Spot Safety Device with Reflectors can be utilized and applied by drivers within many modes of transportation. These different modes of transportation include the following: Recreational Vehicles, Motor Homes, Construction and Mobile Home Trailers, Interstate construction crew's service trucks, Automobile and Sport Utility Vehicles.

I claim:

1. A safety device used for Identifying Blind Spot areas comprising:
(a) A small sheet of metal
(b) Decal with Adhesive Backing
(c) Reflective materials emphasizing precautionary warning
(d) Reflectors
Whereby said safety device with metal backing identifying marked blind spot.

2. The safety device of claim 1 wherein said precautionary warning is secured by self-tapping sheet metal screws.
